(19) United States
(12) Patent Application Publication
(10) Pub. No.: US 2005/0159548 A1
(43) Pub. Date: Jul. 21, 2005

(54) Miscible blends of normally immiscible polymers

(76) Inventor: Jean-Pierre Ibar, Wallingford, CT (US)

Correspondence Address: Alfred D. Lobo & Co., L.P.A., 933 The Leader Building, 526 Superior Avenue E, Cleveland, OH, 44114, US

(21) Appl. No.: 11/036,502

(22) Filed: Jan. 16, 2005

Related U.S. Application Data
(63) Continuation-in-part of application No. 10/759,769, filed on Jan. 17, 2004.
(63) Continuation-in-part of application No. 10/758,892, filed on Jan. 16, 2004.

(51) Int. Cl. C08L 53/00

(52) U.S. Cl. 525/96

(57) ABSTRACT

First and second virgin polymers, not normally miscible when combined in one or more conventional melt-processing means, are combined in a known melt-processing means having mechanical vibration, referred to as a TekFlow® “processor” in which the polymers are extensively shear-thinned, substantially disentangled and stress-fatigued. A process in which melts of each virgin polymer are separately modified, mixed and melt-processed in a conventional extruder, is also effective if the melt of one polymer, modified in a processor, is mixed with virgin melt before being modified in another processor. In each embodiment, the resulting blend is unexpectedly found to be a single phase, that is, a miscible blend.

### CROSS-REFERENCE TO RELATED APPLICATION

This application is a continuation-in-part of Ser. No. 10/759,769 filed 17 Jan. 2004 and Ser. No. 10/758,892 filed 16 Jan. 2004.

### FIELD OF THE INVENTION

A novel melt-blending process produces a polymer blend in which one polymer is miscible in at least one other polymer having a different chemical structure, that is of a different genus, or, a first polymer of the same genus as a second polymer but of so different a molecular weight that the two structurally similar polymers normally form a blend containing more than one phase.

### BACKGROUND OF THE INVENTION

The difficulty of preparing a miscible blend, or alloy of two polymers having substantially different physical characteristics known to make one polymer incompatible with another, is well known. A miscible blend or alloy is defined as a blend in which the polymer components are present in a single phase.

Typically, where chemically similar polymers, that is polymers having the same structural formula, and having relatively close molecular weights, e.g. one more than about one-half (50%) the molecular weight of the other, are melt-blended, they form a single phase blend. However, when the molecular weight of such polymers are widely divergent, the result is a blend which is not a single phase, therefore not uniform or homogenous. This is usually readily evident if the resulting blend is opaque or only translucent though each of the polymers in the blend is normally transparent, that is, essentially completely permeable to visible light.

The Problem:

Even when the solubility parameters of two polymers are relatively close, and the melt flow indices (“MFIs”) are not widely separated, two structurally similar polymers may nevertheless fail to provide a single phase blend when one is present in a substantial amount relative to another, that is sufficient to be normally immiscible in the blend. By “normally immiscible” is meant that the polymer components of the blend, in the respective proportions present, when melt-blended in a conventional melt-processing or mixing means such as a single-screw extruder, twin-screw extruder, Banbury mixer, or the like, results in a blend having more than one phase. As little as 5% by weight of one may result in a blend in which it is not miscible. Since the purpose of making a polymer blend is to inculcate properties absent in either of its components, a typical blend contains more than 5% of each component. Moreover, even if one can make a single phase blend, using a co-solvent for two or more polymers at least one of which is normally immiscible with another, it is impractical to do so. Therefore, a process is required to melt-process at least two normally immiscible polymers and produce a single phase blend.

Formation of an opaque or translucent blend, atypical of a single phase or alloy, is exemplified by an attempt to make a single phase blend of two common polycarbonates (“PCs”), one having a weight average molecular weight Mw of 14,600 with a melt flow index of 73.0 (300° C./1.2 Kg) (referred to as an injection-molding grade PC), and another having a Mw of 28,300 with a melt flow index of 4.8 (300° C./1.2 Kg) (referred to as an extrusion-grade PC).

One would expect that, even with polymers having widely divergent molecular weights, a small proportion (say 10% by weight) of one should be miscible in a very large proportion (say 90% by wt) of the other. It is not. Therefore, as the proportions of each approach each other, the difficulty of making a miscible blend would be expected to increase—and it does.

When the polymers are from different chemical genus, for example one is a PC and the other polyethylene terephthalate (PET), the likelihood of forming a single phase blend diminishes, so that one skilled in the art must rely on trial and error to determine at what ratio of the respective components, a single phase can be formed, if at all. This is found to be generally true even with a small proportion (e.g. 10% by wt) of one polymer in a very large proportion (e.g. 90% by wt) of the other.

In the particular instance of one seeking to prepare a polymer having a molecular weight intermediate the molecular weights of two readily available “like” polymers, that is, one chemically similar to the other and having similar physical characteristics taking into account their respective divergent molecular weights, a simple but impractical method is typically employed. Both polymers are dissolved in a common solvent at a temperature below which the more thermally sensitive polymer is degradable, and the solvent is then driven off. Often the resulting polymer is a single phase and has approximately the desired molecular weight.

As will readily be evident, this method of recovering a single phase blend from a co-solvent for two or more polymers is impractical.

How to modify the physical and physico-chemical characteristics of a polymer, and how to make a “stress-fatigued” melt which is fluidizable at a temperature below the virgin polymer's conventional fluidization temperature, is disclosed in U.S. Pat. Nos. 4,469,649; 5,306,129; 5,494,426; 5,885,495; and 6,210,030 issued to Ibar. In the '495 process, virgin polymer, that is, polymer conventionally manufactured and purchased in the market place, is extruded to form a melt which is then led into an apparatus referred to as a TekFlow® processor, available from Stratek Plastic Ltd. (Dublin, Ireland) and SPRL Inc.(Wallingford, Conn., USA). The melt is mechanically vibrated and fatigued until the state of entanglement between the molecules has been modified to a desired level of disentanglement as measured by a decrease of at least 10% in the viscosity and melt modulus of elasticity relative to that of the virgin melt. The resulting polymer, referred to herein as being “disentangled”, “extensively shear-thinned”, or “stress-fatigued” is referred to herein as “modified” polymer melt (for brevity), and is characterized by having a fluidization temperature at least 10° C. lower than the fluidization temperature of the same virgin polymer had it not been extensively shear-thinned and stress-fatigued.

The '495 patent states: “Yet, in another embodiment of the present invention, the vibrated melt per the present invention is extruded or co-extruded with other melts and additives, and pelletized just after the vibration treatment is performed to obtain solid granules or pellets of the treated melt. The extrusion is done in a way which minimizes the recovery process to take place, for example, under minimum pressure in the case the vibration treatment reduced the viscosity of the melt by extensional shear to reduce the entanglements, and conversely, under minimum shear in the case the vibration treatment increased the elasticity of the melt by favoring the interpenetration of the macro-molecules and increasing the entanglements.” (see '495, col 6, lines 12-24).

Nevertheless, it is not known that in a step-wise, non-continuous process, two immiscible polymers may (i) each be extensively shear-thinned in a processor; (ii) each separately recovered as polymers with disentangled polymer chains; then, (iii) melt-blended without a plasticizer or processing aid, in a conventional mixing means such as a co-rotating twin-screw extruder to yield a single phase blend.

Effective as such a step-wise process may be, it is impractical because it is usually uneconomical.

### SUMMARY OF THE INVENTION

A continuous process is disclosed for melt-blending polymers which normally produce a multi-phase blend (“immiscible polymers”) when melt-processed in a conventional process in the absence of a plasticizer or compatibilizing agent.

It has been discovered that when immiscible polymers are combined in a known melt-processing means, referred to as a “processor” or “stress-fatiguing means”, having mechanical vibration in which the polymers are extensively shear-thinned and melt-fatigued so as to substantially disentangle the polymer chains, the resulting blend is unexpectedly found to be a single phase, that is, a miscible blend. By “substantially disentangled” is meant that the viscosity of the virgin polymer is reduced at least 10%, measured under the same conditions. The “melt” of polymers processed herein refers either to a single polymer or a miscible blend of two or more polymers at or above the fluidization temperature of the polymer or blend, and each polymer may be crystalline, partially crystalline or amorphous.

In one embodiment of the invention, a first processor is adapted to substantially disentangle the polymer chains of virgin (unmodified) first polymer to yield a modified first polymer and feed it to a mixing station; the modified first polymer is then continuously mixed with a virgin second polymer fed from a conventional melt-processing means at the mixing station; and the polymers are together continuously fed from the mixing station to a second processor where the polymer chains of the second polymer are disentangled sufficiently to blend with the first polymer and form a single phase blend.

In a second embodiment of the invention, a first processor is adapted to substantially disentangle the polymer chains of virgin first polymer to yield a modified first polymer and feed it to a mixing station; a second processor is adapted to substantially disentangle the polymer chains of virgin second polymer to yield a modified first polymer and feed it to the mixing station; and the polymers are together continuously fed from the mixing station to a conventional melt-processing means where substantially disentangled polymer chains of both first and second modified polymers are blended to form a single phase blend.

In each process, blending requires a pair of cooperating processors, each substantially disentangling molecules of one or both polymers so as to lower the temperature of fluidized unmodified polymer entering a processor by at least 10° C., preferably in the range from about 20° C. to 50° C., at the discharge-end of the processor.

This invention makes it even possible to make a single phase blend of a substantially crystalline polymer and an amorphous one; e.g. PET/PC blends (alloys) which have flexural properties better than those of either of its unmodified polymer components; more unexpectedly, the MFI of the blend is almost 50% higher than that of the PET component, making this blend a novel PET/PC alloy particularly well-adapted for injection molding parts out of both recycled and virgin resins, and in each case, providing improved mechanical properties.

The work or power input per unit volume of melt, for making the single phase blend by the continuous process of this invention is substantially less, typically from 10% to 50% less than would be required if each component of the blend is separately modified, the disentangled melt recovered, cooled and pelletized; and pellets of each polymer are combined in the desired proportions to produce a blend. The actual power input required is a function of the rheological properties of the melt at the mixing temperature, the relative concentration of the polymer components, the condition of fluidized melt flowing from a particular conventional melt-processing means into the processor, and the desired throughput of blend. A typical power input for a TekFlow® processor to make a 50/50 blend of a high flow polycarbonate (PC) having a melt flow index (MFI) in the range from about 40-100, with a low flow PC having a melt flow index (MFI) in the range from about 1-20, is in the range from about 100-1000 Joules/ml.

### BRIEF DESCRIPTION OF THE DRAWINGS

FIG. 1 is a process flow diagram schematically illustrating sequential steps in a first embodiment of the process.

FIG. 2 a process flow diagram schematically illustrating sequential steps in a first embodiment of the process.

FIG. 3 sets forth the tensile properties of virgin PC (1) and a single phase blend of 50% PC/50% PET by wt, plotted as stress (MPa) against elongation (%); the speed of testing is 50 mm/min.

FIG. 4 sets forth the tensile properties of virgin PC (1) having a Mw=20,680 and a single phase blend of two other virgin PCs, PC2 & PC3 in a 50% PC(2)/50% PC(3) ratio by wt, plotted as stress (MPa) against elongation (%); the speed of testing is 50 mm/min.

FIG. 5 sets forth curves plotted as “normalized heat flow, watts/gm (Wg⁻¹)” against temperature (° C.) obtained from DSC after the blend of 50 PC/50 PET has been heated a second time.

FIG. 6 sets forth curves plotted to compare the % elongation of a blend of 50/50 PET/PC with that of each virgin polymer by thermomechanical analysis in the parallel direction, of strands of each.

FIG. 7 sets forth GPC curves showing dW/dLog Mi along the ordinate, where W is weight and Mi represents molecular weight segments; and Log Mi showing the distribution of molecular weight segments, along the abscissa. The peaks of the curves represent Mw, the far right along the abscissa represents Mz, and the far left along the abscissa represents Mn.

FIG. 8 sets forth correlations for Mn, Mw and Mz, plotting average molecular weight M_{avg} against the concentration of low melt flow PC in each blend.

FIG. 9 is a straight line correlation for melt flow index of each blend against its molecular weight scaled to the power −3.4.

### DETAILED DESCRIPTION OF THE INVENTION

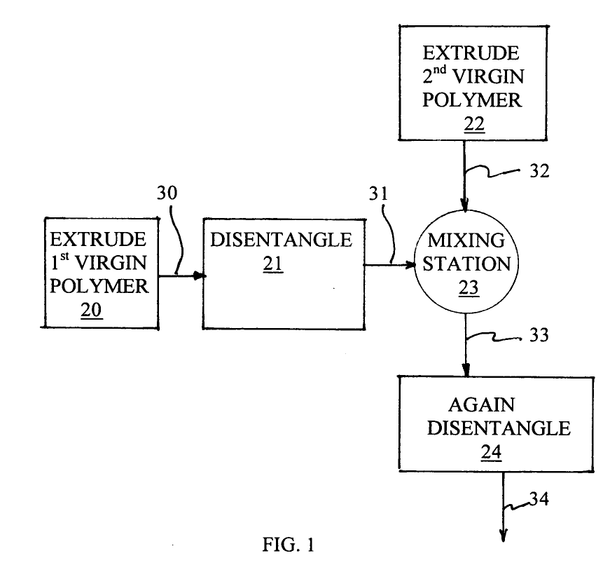

Referring to FIG. 1, there is illustrated a first embodiment of a blend-forming system to melt-produce a miscible blend from first and second virgin polymers, comprising a conventional melt-processing means, e.g. extruder 20, a first stress-fatiguing means 21 (first TekFlow® processor), a second conventional melt-processing means, e.g. extruder 22 for supplying a second virgin polymer, and a second stress-fatiguing means 24 (second TekFlow® processor), with an interposed mixing station 23, this being a location where the melt of second polymer is introduced into the melt of first polymer, intermediate the first stress-fatiguing means 20 and second stress-fatiguing means 24.

In operation, virgin polymers (not shown) are fed to and extruded from the extruders 20 and 22 at a temperature in the range from about 20° C.-100° C. above the melting temperature of the respective virgin polymers; extrudate 30 from extruder 20 is flowed continuously to the stress-fatiguing means 21. After being shear-thinned, the melt-fatigued effluent 31 is led to the mixing station 23 where the second polymer 22 is continuously metered into mixing station 23 through conduit 32 for further melt-processing, though poorly, to form a mixed blend with the stress-fatigued first and disentangled polymer 31. This blend 33 is led into the feed inlet of the second processor 24 where the blend is further blended and the polymers further disentangled. Each stress-fatiguing means 21 and 24 supplies a sufficiently high power input per unit volume of melt to obtain the extent of shear-thinning desired. Stress-fatigued blend 34 is recovered and cooled. The cooled solid is tested and found to be a single phase blend.

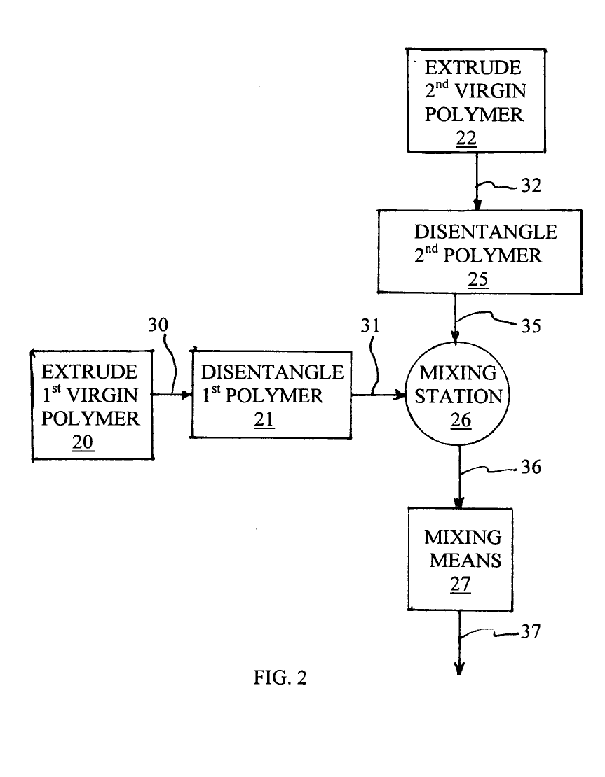

Referring to FIG. 2, there is illustrated a second embodiment of a blend-forming system to melt-produce a miscible blend from first and second virgin polymers, comprising a conventional melt-processing means, e.g. extruder 20, a first stress-fatiguing means 21 (first TekFlow® processor) to modify the first polymer, a second conventional melt-processing means, e.g. extruder 22 for supplying a second virgin polymer, and a second stress-fatiguing means 25 (second TekFlow® processor) to modify the second polymer. The modified first and second polymers flowing through conduits 31 and 35 respectively are led to a mixing station 26 where the polymers are relatively poorly mixed. The mixing station 26 is a location where the melt of second polymer is combined with the melt of first polymer, so as to feed the polymers together through conduit 36 to a conventional melt-processing or “mixing” means 27, e.g. a single screw extruder, or preferably, a co-rotating twin-screw extruder. Since the polymer chains of each polymer have already been substantially disentangled, the conventional mixing means 27 is unexpectedly effective to combine the two modified polymers into a single phase blend. Stress-fatigued blend 37 is recovered and cooled. The cooled solid is tested and found to be a single phase blend.

It will be appreciated that the power input per unit volume of material in the processors will vary depending upon a host of variables including the physical characteristics of the polymer, those of the additive, the concentration of the additive, the temperature range in which the processors (21) and (24) are operated, the design parameters of each shear-thinning apparatus, and most importantly, the degree of disentanglement until a single phase blend is obtained.

For each processor (21) and (24), the power requirements will vary in the range from 0.5 HP/(kg/hr) to 75 HP/(kg/hr), depending upon the rheological properties of each polymer and the blends to be produced. Typically the polymer having a lower requirement will typically operate in the range from about 2 HP/(kg/hr) to 10 HP/(kg/hr), and one having a higher will typically operate in the range from about 10 HP/(kg/hr) to 30 HP/(kg/hr). It will be realized that it is not essential that one processor or conventional extruder be operated with a lower power requirement than the other.

It will now be evident that after feeding a virgin first polymer melt from a conventional first melt-processing means, e.g an extruder, to a first stress-fatiguing means, e.g. a processor, and removing modified polymer from it, one may choose to feed a virgin second polymer either directly from a conventional second melt-processing means, e.g. an extruder, to a mixing station; or, to feed the second polymer melt to a second processor, and then to the mixing station.

In either case the polymers are mixed in the desired proportion prior to being fed to the mixing station, though mixed poorly, before being further processed. If the polymer chains in each polymer have been disentangled, then only a conventional third melt-processing means, e.g. a third extruder, is necessary to finish blending the polymers and produce a single phase blend. On the other hand, if the second virgin polymer is mixed with modified first polymer at the mixing station, then it is essential that one choose to use a second processor. The effluent blend from the second processor contains enough substantially disentangled polymer chains of each polymer to form a single phase blend which is then recovered and cooled.

The range within which a fluidization temperature is chosen for melt-processing each of several common polymers to be additive-enriched, is presented in Table 1 below, it being recognized that the chosen fluidization temperature for operation is at or above a fluidization temperature in the range, and operation at a temperature above the range is usually unnecessary and uneconomical even if the polymer is not thermally sensitive.

TABLE 1
Ranges of Conventional Fluidization Temperature
for Common Polymers

| Polymer | Range (° C.) |
|---|---|
| Polyethylene (PE) | 180-220 |
| Polypropylene (PP) | 205-235 |
| Polycarbonate (PC) | 265-315 |
| Polyamide (PA) | 270-300 |
| Polystyrene (PS) | 220-240 |
| Polyethylene Terephthalate Glycol (PETG) | 260-280 |
| Polyethylene Terephthalate (PET) | 250-275 |
| Polymethyl Methacrylate (PMMA) | 220-240 |

In one preferred embodiment, pellets of an extrusion grade PC are mixed with an injection molding grade PET. The PET has an IV of 0.84. The PC/PET blend is pre-mixed in a 50/50 proportion using a tumbler and loaded in a Novatech drier for drying overnight at 120° C. Adequate drying is important, particularly in the case of the PC/PET mixture because PET is sensitive to hydrolysis and requires aggressive drying such that moisture content is below 0.003%.The PET is blended with a low flow PC (molecular weight of 28,300 and a melt flow index of 4.8) and the blend alloyed in a TekFlow® processor using either embodiments shown in FIG. 1 or 2.

A similar procedure is employed using two grades of PC. In each case, whether PET/PC or PC/PC, the melt is processed at low temperature, low pressure, and under high throughput conditions, made possible by the action of shear-thinning and disentanglement produced by cross-lamination under extensional flow and mechanical shear vibration in the TekFlow® processors. The melt exiting the TekFlow® processor is transparent and homogenous, indicative of a single phase. Analytical testing indicates that the PC/PET alloys present all the characteristics of a molecularly fused new material, exhibiting a single Tg, no cold crystallization, no crystallization at all, and high fluidity. It is shown that the single phase PC/PET blends have better flow characteristics than PET. As shown below, the PC/PC alloy has the same mechanical characteristics as its reference counterparts, at same Mw.

Melt Flow Rate Measurement:

The melt flow rate measurements are performed as described in ASTM D1238. A Laboratory Melt Indexer model LMI 4000 by Dynisco was used.

The procedure used to test the MFI of the materials as been refined to prevent moisture pick up at every step. The samples are dried in unsealed bags in a vacuum oven at 120° C. overnight. The vacuum is broken using N₂. Then the bags are taken out and immediately sealed. As for the MFI test itself, the bottom of the barrel of the MFI machine is blocked, then the barrel is filled with N₂ using a glass pipette. Feeding of the material into the barrel (about 5 g) is also performed under N₂. After 3 min of pre-heating at 300° C., a 1.2 Kg weight is loaded on the piston to extrude the material through the die. Melt flow rate measurements are performed twice on each sample.

Molecular Meight Measurement:

Molecular weight measurements are performed using a Waters 150CV+automated GPC apparatus. For PC, a 2% w/v of PC sample is dissolved in THF @ 55° C. for five hours, shaking all the way. After cooling, a 0.2% w/v solution is prepared from the 2% solution and injected @ 30° C. (column and pump are also set @ 30° C.) at a flow rate of 1 ml/min with a pressure of 120-124 bars. RI is the measured parameter for the molecular weight distribution of PC.

For the PC/PET blend, only the PC component was studied by GPC. CHCl₃ was used to extract the PC. In this case, chloroform is a good solvent to extract the PC because it swells the PET and facilitates the PC extraction. About 80 mg of sample is put into a 4 ml vial along with 4 ml of CHCl₃ to dissolve the PC. The vial is heated at 50° C. for 5 hr with shaking frequently, followed by rotating at room temperature overnight. Then the liquid is filtered into another 4 ml vial. The remaining solid is washed with 0.5 ml of chloroform and filtered again. Then, the solutions are combined and evaporated overnight to recuperate the PC. The PC is then prepared for GPC analysis following the procedure described above for the PC/PC blends.

The column is phenogel having pore sizes 10⁵, 10⁴, 500 Å. Reference samples (Virgin PC) are included in each carrousel (carrying 16 samples at a time) to provide a reference. For the PC blends, the references were made in the laboratory for each PC(1)/PC(2) proportion and their molecular weight were compared with the processed blends. Molecular weights are determined with respect to PS standards. The values of Mn, Mw and Mz are corrected for PC using published values for the Mark-Hawking constants at 25° C.

Thermal Mechanical Analysis:

Thermal mechanical analysis (TMA) is used to compare the softening temperature of the PC/PET blend with those of the virgin PC and PET resins. The tests are performed under N₂ using a TMA-80 from Mettler with a flat probe and a 0.1N force. The samples were heated up to 320° C. at a heating rate of 20° C./min, then cooled back to room temperature at 10° C./min.

Tensile Properties:

Dog bones and flexural bars are injection molded on a 150 ton Van Dorn machine for the blends and also for the virgin PC and virgin PET. For each, tensile tests were performed following ASTM D639 at a crosshead speed of 50 mm/min. The reported values are the average properties measured on five different tensile tests.

Flexural Tests:

The properties for Virgin PET and PC were taken from the literature. The flexural properties of the PC/PET blend and virgin resins are determined using a three-point loading system. The tests are performed following ASTM D790. The reported values are the average properties measured on five different flexural tests.

The MFIs and molecular weights Mw of the virgin PC and virgin PET used to make the blends herein are as follows:

TABLE 2

| | MFI 300° C./1.2 Kg | |
|---|---|---|
| Polymer | (g/10 min) | Mw |
| Polycarbonate (PC) | 4.8 | 28,300 |
| Polyethylene terephthalate (PET) | 11.7 | — |
| 50/50 PC/PET single phase blend | 17.8 | 13,600 |

It is evident that the MFI of the blend is higher than that of either component, evidently due to the combination of disentangled polymer chains from each polymer and just as evidently wholly unexpected. Longer molecular weight PC chains are entangled with PET sections creating a gel which cannot be dissolved nor analyzed by GPC.

The tensile properties of the single phase blend are found to be as follows:

TABLE 3

| | At yield | | | At break | |
|---|---|---|---|---|---|
| | Tens str'th | Elong'n | | Tens str'th | Elong'n |
| Polymer | (MPa) | (%) | Cold draw'g | (MPa) | (%) |
| Virgin PC | 62.5 | 7.0 | 51.0 | 71.7 | 110.4 |
| Virgin PET | 54.5 | 3.8 | — | 55.0 | 130.0 |
| 50/50 PC/PET | 66.2 | 3.9 | 46.8 | 47.4 | 119.8 |

The flexural properties of the 50/50 PC/PET are measured to compare them to those of the individual virgin polymers, as follows:

TABLE 4

| | Flex modulus | Flex strength at |
|---|---|---|
| Polymer | secant at 1% | 5% strain (MPa) |
| PC | 1.73 | 79.4 |
| PET | 1.00 | 80.0 |
| PC/PET | 1.95 | 90.4 |

Several blends are prepared by mixing various proportions of a low flow PC(1) and a high flow PC(2) having the molecular weights given below, and the molecular weights of the single phase blends of disentangled polymers is compared to the molecular weights of blends, in the same proportions, of virgin polymers which were together dissolved in a co-solvent and then recovered from the solvent.

TABLE 5

| | | Mw | Mw |
|---|---|---|---|
| Polymer | MFI | Disent'gled chains | from sol'n |
| Virgin PC(1) | 4.8 | 28,300 | — |
| Virgin PC(2) | 73.0 | 14,600 | — |
| 90PC(1)/10PC(2) | 7.0 | 26,090 | — |
| 80PC(1)/20PC(2) | 10.3 | 24,135 | 25,330 |
| 70PC(1)/30PC(2) | 12.0 | 23,050 | 24,225 |
| 60PC(1)/40PC(2) | 14.8 | 21,700 | 22,820 |
| 50PC(1)/50PC(2) | 18.9 | 20,680 | 21,420 |
| 40PC(1)/60PC(2) | 25.2 | 19,280 | 20,175 |
| 30PC(1)/70PC(2) | 38.0 | 17,300 | 18,740 |
| 20PC(1)/80PC(2) | 48.1 | 16,384 | 17,155 |

The tensile properties of a single phase blend of 50/50, low and high flow PCs PC(1) and PC(2), is found to have a Mw of 20,680. The tensile properties of each virgin PC are compared to those of the single phase blend.

Separately, a virgin PC(3) polymer is made having a Mw of 20,680, to match that of the single phase blend. The tensile properties of this PC(3) are also measured to compare them to those of the single phase blend having the same Mw. The values are found to be as follows:

TABLE 6

| | At yield | | | At break | |
|---|---|---|---|---|---|
| | Tens str'th | Elong'n | Cold | Tens str'th | Elong'n |
| Polymer | (MPa) | (%) | draw'g | (MPa) | (%) |
| Virgin PC(1) | 62.5 | 7.0 | 51.0 | 71.7 | 110.4 |
| Virgin PC(2) | 60.1 | 6.0 | — | 48.0 | 60.0 |
| 50/50 PC(1)/PC(2) | 66.2 | 3.9 | 46.8 | 47.4 | 119.8 |
| PC(3) | 61.1 | 5.5 | 53.0 | 64.7 | 96.8 |

It is evident from the foregoing that the properties of the single phase blend closely match those of the virgin PC(3).

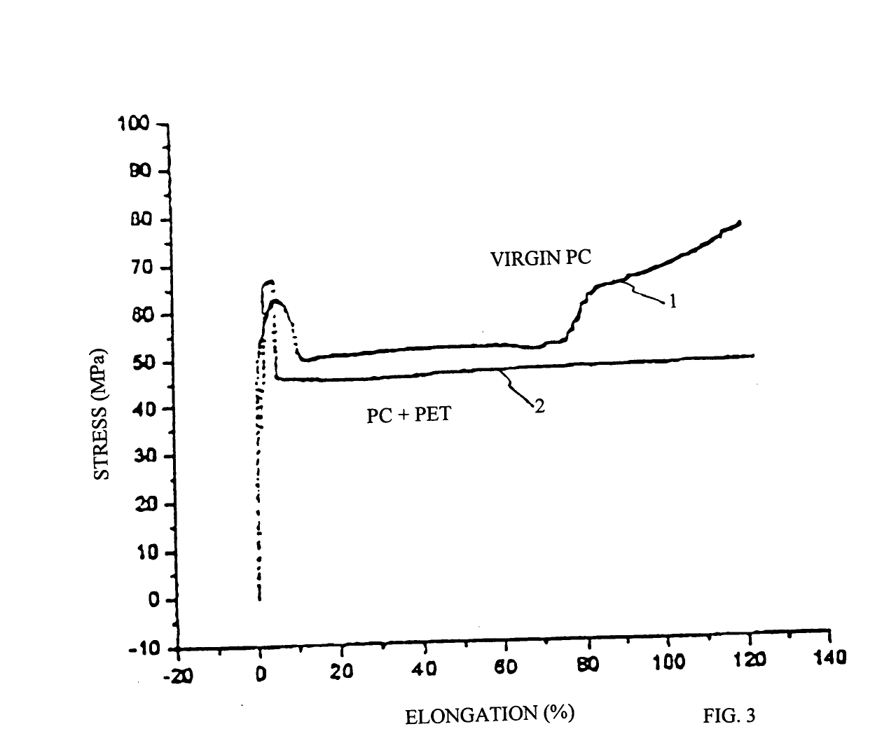

Referring to FIG. 3 it is seen that the curve for virgin PC, identified by reference numeral 1, the tensile strength at yield is 62.3 MPa; the elongation at yield is 5.9%; the ultimate tensile strength is 50.8 MPa; and the elongation at break is 63.9%. In the curve for the blend of virgin PC (50%) and virgin PET (50%), identified by reference numeral 2, the tensile strength at yield is 62.1 MPa; the elongation at yield is 8.2%; the ultimate tensile strength is 68.5 MPa; and the elongation at break is 106.6%.

It is evident from the data presented in curves 1 and 2 in FIG. 3 that despite having 50% PET in the blend there is essentially no diminution of the mechanical properties relative to those of virgin PC. The PC/PET blend has a tensile strength at yield higher than either the virgin PC or the PET. Elongation at and tensile strength at break is comparable to the properties of virgin PET.

The mechanical properties of a virgin polymer PC(2) having a specified Mw=20,680 are compared to those of a blend made by the process of this invention, which blend is made from two PC polymers PC(1) Mw=28,300 and PC(3) Mw=14,600 to yield a blend having the same Mw=20,680 as the virgin polymer PC(2).

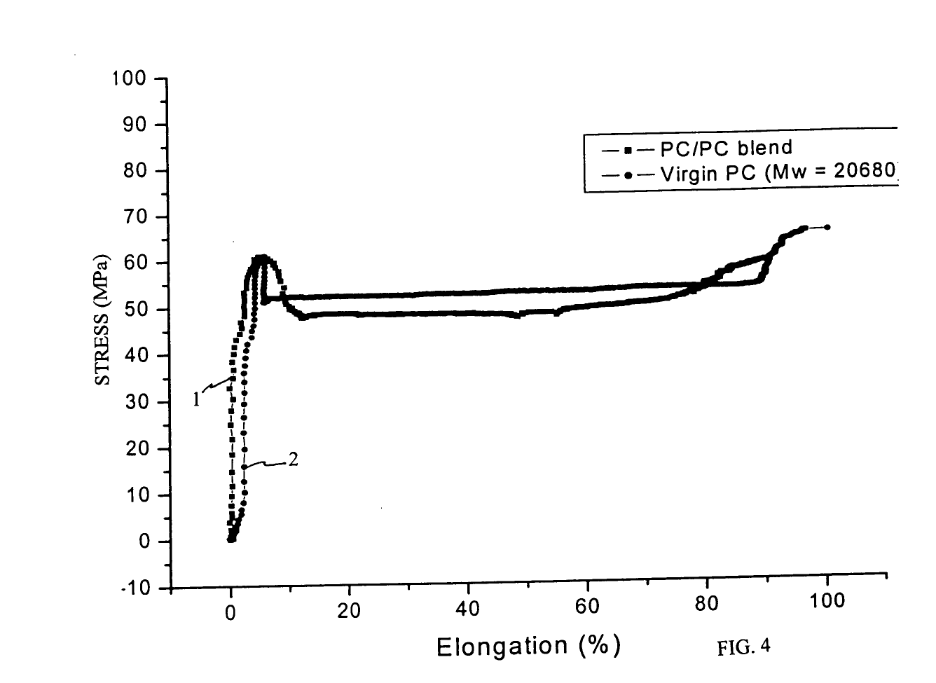

Referring to FIG. 4 it is seen that the curves for virgin PC Mw=20,680, identified by reference numeral 2, and for the blend of PC(1)/PC(3) the tensile strength at yield, the elongation at yield and the ultimate tensile strength are closely matched though the elongation at break of the blend is slightly lower.

It is evident from the data presented in curves 1 and 2 in FIG. 4 that despite being blended, the single phase blend has mechanical properties closely matching those of the virgin polymer, providing evidence that the miscible blend behaves like a virgin polymer having the same Mw.

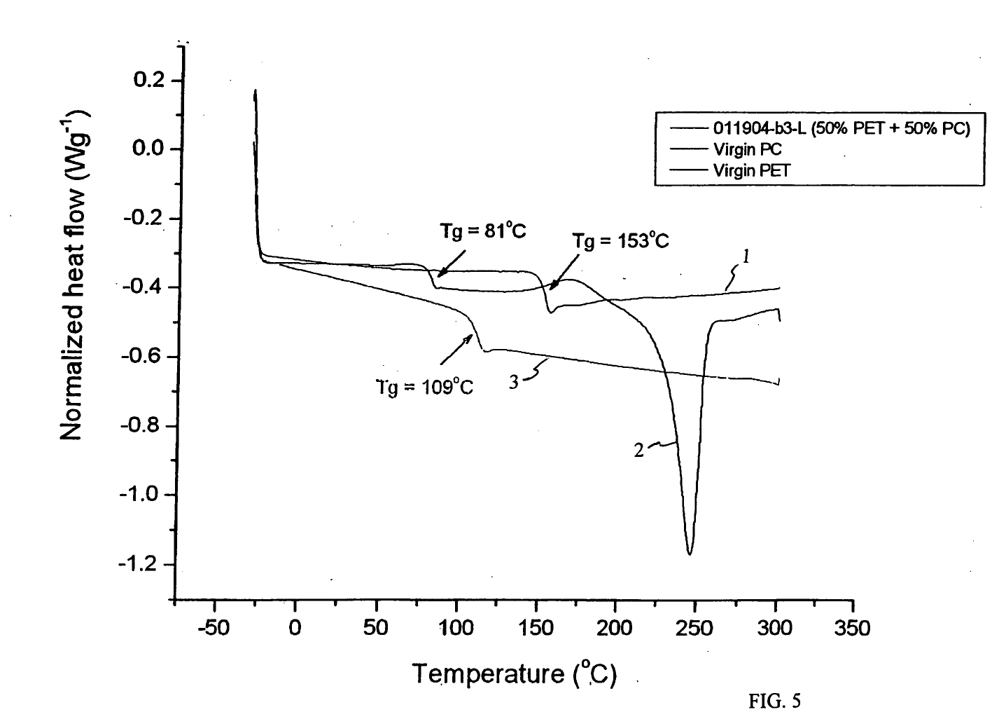

Referring to FIG. 5, three curves are presented, the first (1) for virgin PC; the second (2) for virgin PET; and the third (3) for the 50/50 blend of the PC and PET. It is evident from the relatively flat curve (1) for PC that PC is amorphous, showing a Tg of 153° C. From the curve (2) for virgin PET it is evident that it is partially crystalline, indicating a Tg at 81° C., then a relatively flat portion followed by a slight bump indicating cold crystallization at about 145° C., and then a steep drop to an inverted peak at 245° C. indicating the polymer is beginning to melt. The curve then rises to about 260° C. where the polymer polymer has finished losing its crystallinity, until soon after, it becomes amorphous.

The curve (3) is obtained on a blend which has been heated twice. Typically, a blend heated only once may generate a curve based on the instability of the blend. Obtaining a DSC curve after a second heating ensures against that being the case. An examination of the curve (3) indicates that the blend has a single Tg, evidence that there is only a single phase present. Moreover, the Tg is at 109° C., which is exactly the theoretical value for a perfect blend of two polymers with Tg=71° C. and Tg=153° C., and the relatively flat curve (3) is evidence that the blend has lost essentially all its crystallinity and behaves as an amorphous polymer. The blend is more readily flowable than either of its components affording an unexpected processing advantage in any melt-processing apparatus.

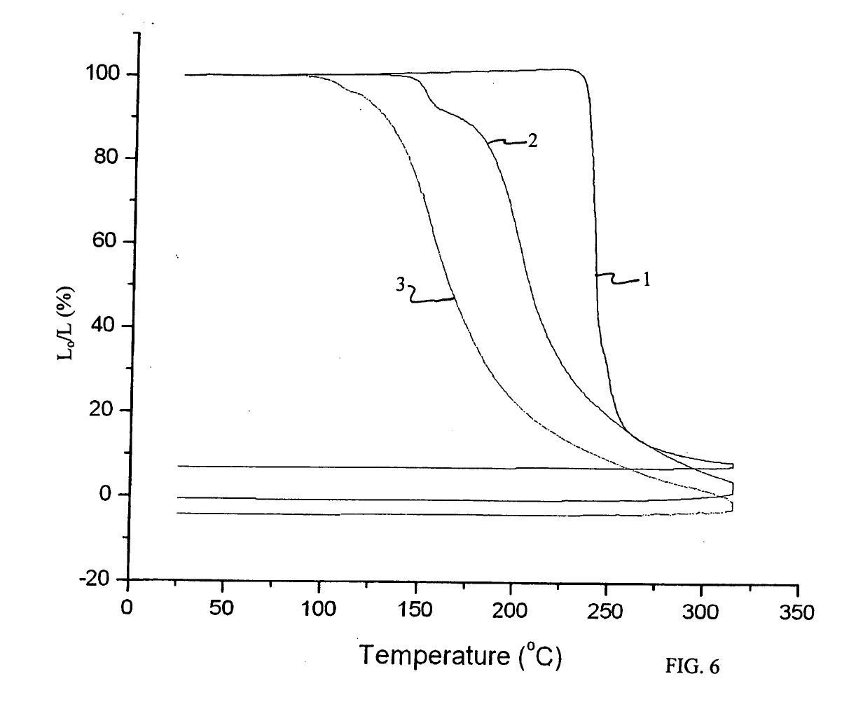

Referring to FIG. 6 curve (1) is for virgin PET, curve (2) is for virgin PC and curve (3) is for the 50/50 blend. The tests are run as set forth in ASTM D ??? using a strand about 2 mm in diameter, cut in the parallel (machine) direction. It is evident that the crystallinity of the PET results in the curve following along the abscissa until at about 225° C. it suddenly drops; curve (2) for amorphous PC commences to drop much earlier at about 140° C. but does not drop precipitously; and curve (3) for the blend, despite having 50% PET, unexpectedly commences to drop at about 80° C. which is even earlier than the curve for virgin PC.

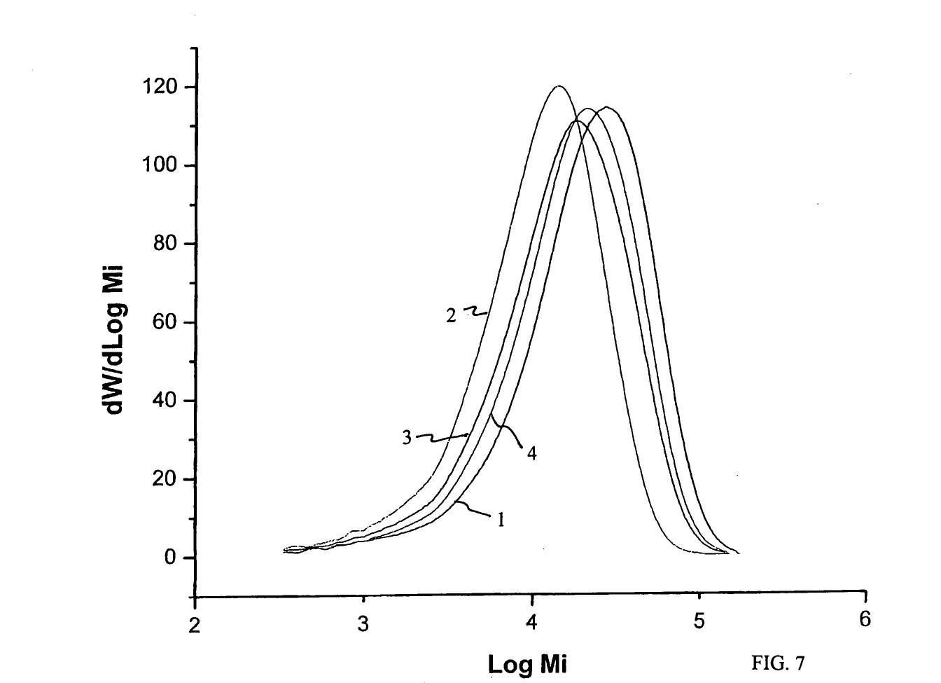

Referring to FIG. 7 there is shown a set of four curves: curve (1) is for virgin PC(1) (MFI=4.5); curve (2) is for virgin PC(2) (MFI=78), both MFIs measured at 300° C./1.2 Kg; curve (3) is a blend of 50% PC(1)/50% PC(2); and curve (4) is for a blend of 70% PC(1)/30% PC(2).

It is evident that the curves for the blends have sharp, uncluttered peaks similar to the peaks for the virgin polymers with no visible trace of a bimodal distribution. Moreover, the shape of the molecular weight distribution of the segments has remained essentially unchanged.

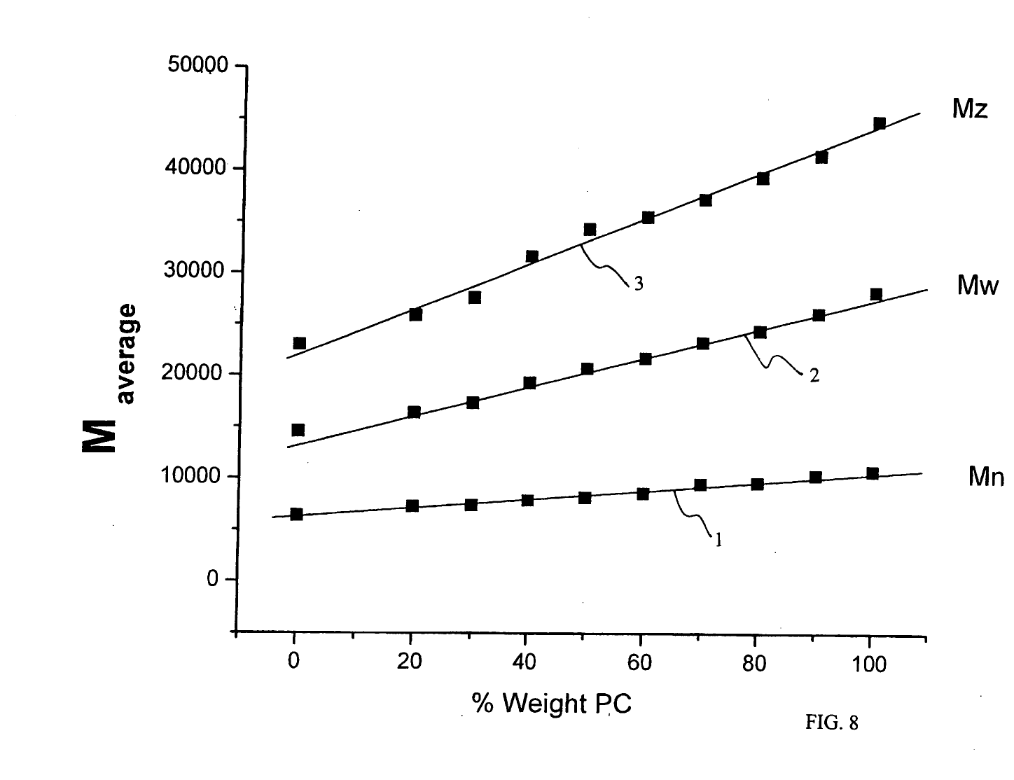

Referring to FIG. 8, curves (1), (2) and (3) for Mn, Mw and Mz respectively, are plotted for ten (10) points versus “x” % by wt from 0% to 100% by wt of a low flow PC (MFI=4.8) having a Mw of 28,300 in eight (8) blends with a high flow PC (MFI=14,600) as set forth in Table 5 above. The average molecular weight Mw of the blends is plotted on the ordinate, and the content of low flow PC is plotted along the abscissa. It is evident that the relationships are essentially linear, indicating that one can tailor a blend to have a desired average molecular weight and be reasonably assured what its physical properties will be.

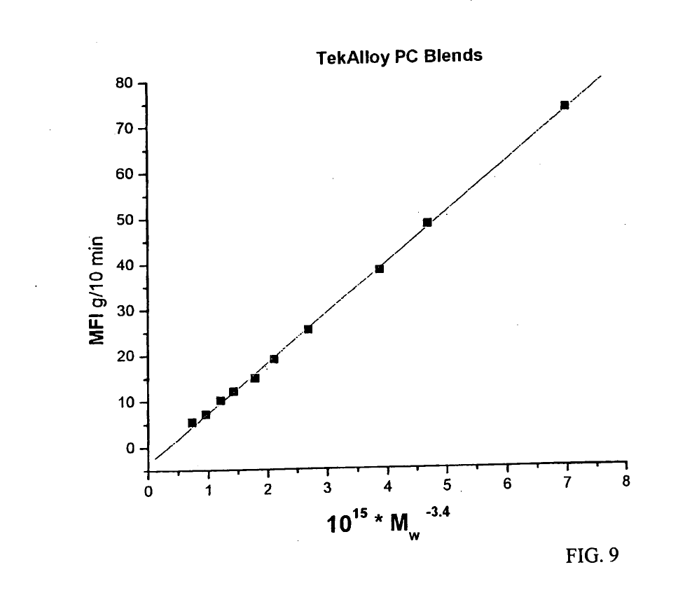

Referring to FIG. 9, note that the points plotting melt flow index of each blend against its molecular weight (scaled to the power −3.4) is essentially a straight line with its intercept at 0, confirming the theoretical correlation based on 3.4 as a power level.

In a manner analogous to that described for making blends of amorphous polymers (PCs) having widely divergent MFIs, and a blend of an amorphous polymer (PC) with a crystalline polymer (PET), single phase blends may be made with normally immiscible polymers in any combination of the categories. In particular, normally immiscible blends of a polyamide, polyimide, polyurethane, polyolefin, and polyester, may now be blended in heterogeneous relative order. Commonly used polymers which may now be blended to yield a single phase blend include high-density (HDPE) and low-density polyethylene (LDPE), polystyrene, polyacrylic acid, polyacrylonitrile, polyarylsulfone, polybutylene, polyisobutylene, polycarbonate, polyacrylonitrile, polycaprolactone, polyoxymethylene (polyacetal), polyphenylene ether, polyphenylene oxide, polyphenylene sulfide, polyetherketone, polyethylene sulfone, ethylene propylene copolymer, polyamide-imide, polybutadiene acrylonitrile, polybutadiene styrene, polybutadiene terephthalate, polyethyl acrylate, cellulose acetate, polyethylene terephthalate glycol, polymethyl acrylate, polymethyl ethyl acrylate, polymethyl methacrylate, polypropylene terephthalate, polytetrafluoroethylene, polyvinyl alcohol, polyvinyl acetate, polyvinyl chloride, polyvinylidene chloride, polyvinylidene fluoride, polyvinyl methyl ether, polyvinyl methyl ketone, styrene butadiene, styrene butadiene rubber, cellulose acetate butyrate, cellulose acetate propionate, cellulose nitrate (celluloid), chlorinated polyethylene, chlorotrifluoroethlylene, ethylene acrylic acid, ethylene butyl acrylate, ethyl cellulose, acrylonitrile, chlorinated PE and styrene, acrylonitrile methyl methacrylate, acrylonitrile styrene, butadiene acrylonitrile, and ethylene propylene diene monomer.

Blends may be made with the foregoing polymers, one with another, even when the molecular weight of one is less than 50% that of the other. By “relative heterogeneous order” is meant that each polymer or copolymer may be independently chosen and blended with another.

The fluidization temperature, as used hereinabove, is defined as that temperature at which the normally solid polymer is conventionally melt-processed without any processing aid to reduce viscosity, this melt-processing temperature being in the range from about 10° C. to 100° C. above the measured melt temperature (at ambient temperature of 25° C. and atmospheric pressure) for a crystalline polymer, or the glass transition temperature of an amorphous polymer, at which the polymer begins to flow. The fluidization temperature and melt-controlling temperature are properties of any polymer whether homopolymer or copolymers, whether of a branched or unbranched monomer (that is, having one or more substituents on the backbone), and as used hereinabove, the term “polymer” refers to each of the foregoing.

As indicated above, novel single phase blends may now be made by the process of this invention, with polymers whether crystalline, partially crystalline or amorphous, irrespective of the category in which each component polymer is placed, provided the polymer chains are sufficiently disentangled, that is, each component is sufficiently modified so as together to form a single phase blend.

To make a blend with two or more polymers, at least one of which has polymer chains which are difficult to disentangle sufficiently in a single processing means, it may be desirable to use more than one processor, the effluent from one being fed to the intake of the other. For example, in FIG. 1, if the first virgin polymer is difficult to modify in a single processor, an additional processor may be introduced after the first processor 21 and the twice-modified polymer fed to the mixing station 23. Alternatively, again referring to FIG. 1, if the second virgin polymer is difficult to modify in combination with modified first polymer, an additional processor may be introduced after processor 24.

In each embodiment, the single phase blend is made essentially free of a plasticizer or compatibilizer. As will be evident, the presence of a plasticizer, or the addition of an adjuvant will typically will typically provide a multi-phase blend, but may be present, particularly in recycled polymer, in an amount which does not adversely affect the desired physical properties of the blend, typically in the range from about 1 to 5% by wt of the plasticized blend.. The term “adjuvant” refers to an emulsifier, perfume, coloring dye, surfactant, processing aid, bactericide, opacifier and the like, commonly added to polymers. In those instances where a plasticizer does not form a separate phase, it may be added in an even larger amount, further to tailor the the desired physical properties of the blend.

As one skilled in the art will appreciate, the difficulty of disentangling polymer chains of any particular polymer is not readily estimated, and typically requires a degree of trial and error one skilled in the art will expected to provide even after acquiring a familiarity with the operation of processors.

Having thus provided a general discussion, described the overall process in detail and illustrated the invention with specific illustrations of the best mode of making and using it, it will be evident that the invention has provided an effective solution to a difficult problem. It is therefore to be understood that no undue restrictions are to be imposed by reason of the specific embodiments illustrated and discussed, and particularly that the invention is not restricted to a slavish adherence to the details set forth herein.

1. In a process for blending a virgin first polymer with at least one other virgin polymer normally immiscible with each other as evidenced by the presence of more than one phase in a blend made with conventional melt-processing means, the improvement comprising,
feeding the virgin first polymer melt from a conventional first melt-processing means to a first stress-fatiguing means and removing modified polymer therefrom;
feeding a virgin second polymer from a conventional second melt-processing means to a first mixing means selectively chosen from a mixing station and a second stress-fatiguing means;
providing a blend of first and second virgin polymers having polymer chains at a chosen level of disentanglement at the mixing station;
feeding the blend from the mixing station to a second mixing means selectively chosen from a third conventional melt-processing means and a third stress-fatiguing means; and,
recovering a single phase blend of the first and second polymers.

2. The process of claim I comprising feeding the virgin second polymer from the conventional second melt-processing means to the second stress-fatiguing means;
forming a blend of modified first polymer and modified second polymer in the mixing station;
flowing blended modified first and second polymers to the third conventional melt-processing means.

3. The process of claim I comprising feeding the virgin second polymer directly from the conventional second melt-processing means to the mixing station;
forming a blend of modified first polymer and virgin second polymer in the mixing station;
and, flowing the blend to the third stress-fatiguing means.

4. The process of claim 1 wherein each virgin polymer is fluidized at a fluidization temperature in the range from 10° C. to 100° C. above the conventional melting point or melt-controlling glass transition temperature of the virgin polymer; and, one polymer is present in an amount at least 5% by weight of the single phase blend.

5. The process of claim 1 wherein the virgin first and second polymer is each independently selected from the group consisting of a substantially crystalline polymer, a substantially amorphous polymer and a partially crystalline polymer.

6. The process of claim 1 wherein the fluidization temperature of virgin first polymer entering the first stress-fatiguing means is at least 10° C. above the melting point or melt-controlling glass transition temperature of the polymer, and the temperature leaving the first stress-fatiguing means is at least 10° C. below the fluidization temperature at which the melt enters the first stress-fatiguing means.

7. The process of claim 2 wherein the fluidization temperature of virgin second polymer entering the second stress-fatiguing means is at least 10° C. above the melting point or melt-controlling glass transition temperature of the polymer, and the temperature leaving the second stress-fatiguing means is at least 10° C. below the fluidization temperature at which the melt enters the second stress-fatiguing means.

8. The process of claim 5 wherein the first polymer has a molecular weight which is less than 50% of the molecular weight of the second polymer, independent of its crystallinity.

9. The process of claim 5 wherein the first polymer is an amorphous polymer and the second polymer is substantially crystalline.

10. A single phase blend of a first virgin polymer with at least one other virgin polymer normally immiscible with each other as evidenced by the presence of more than one phase in a blend made with conventional melt-processing means, the single phase being the product of a process comprising,
feeding the virgin first polymer melt from a conventional first melt-processing means to a first stress-fatiguing means and removing modified polymer therefrom;
feeding a virgin second polymer from a conventional second melt-processing means to a first mixing means selectively chosen from a mixing station and a second stress-fatiguing means;
providing a blend of first and second virgin polymers having polymer chains at a chosen level of disentanglement at the mixing station;
feeding the blend from the mixing station to a second mixing means selectively chosen from a third conventional melt-processing means and a third stress-fatiguing means; and,
recovering the first and second polymers as the single phase blend.

11. The single phase blend of claim 10 produce by feeding the virgin second polymer from the conventional second melt-processing means to the second stress-fatiguing means; forming a blend of modified first polymer and modified second polymer in the mixing station; flowing blended modified first and second polymers to the third conventional melt-processing means.

12. The single phase blend of claim 10 produced by feeding the virgin second polymer directly from the conventional second melt-processing means to the mixing station; forming a blend of modified first polymer and virgin second polymer in the mixing station; and, flowing the blend to the third stress-fatiguing means.

13. The single phase blend of claim 10 wherein the virgin first and second polymer is each independently selected from the group consisting of a substantially crystalline polymer, a substantially amorphous polymer and a partially crystalline polymer.
